(19) United States
(12) Patent Application Publication
(10) Pub. No.: US 2026/0263959 A1
(43) Pub. Date: Sep. 10, 2026

(54) MODULAR SELF-CLIMBING HOIST

(71) Applicant: Bruce William Darden, San Antonio, TX (US)

(72) Inventor: Bruce William Darden, San Antonio, TX (US)

(21) Appl. No.: 19/555,775

(22) Filed: Mar. 3, 2026

Related U.S. Application Data
(60) Provisional application No. 63/766,941, filed on Mar. 4, 2025.

(51) Int. Cl. A63J 1/02

(52) U.S. Cl. CPC A63J 1/028; B66D 1/26

(57) ABSTRACT

A modular hoist system for lifting equipment includes a horizontal truss, hoist modules coupled to the truss, a drive shaft, and a plurality of support plates spaced along the horizontal truss at predetermined intervals. All of the components are removably coupled together so that the system can be disassembled and reassembled in a new location or with a new configuration. The drive shaft extends along the horizontal truss and mechanically couples a first hoist module and a second hoist module such that torque applied by a drive of the first hoist module is transmitted to the second hoist module. A plurality of lift lines coupled to the hoist modules are configured so that the hoist modules raise and lower the horizontal truss relative to an overhead structure. The hoist modules are configured to travel with the horizontal truss as a self-climbing assembly.

### CROSS-REFERENCE TO RELATED APPLICATIONS

This Application claims priority to U.S. Provisional Patent Application No. 63/766,941 filed on Mar. 4, 2025, entitled “Compact Re-Configurable Self-Climbing Hoist,” the contents of which are incorporated herein by reference.

### BACKGROUND

### Field of the Art

The present disclosure is related to the field of modular hoisting systems for entertainment venues, and more particularly to a self-climbing, weld-free truss assembly with interchangeable components for synchronized lifting and lowering of equipment such as lighting, scenery, curtains, and video displays.

### Discussion of the State of the Art

Theaters, concert halls, and other places of assembly require extensive overhead equipment installations for lighting, scenery, and effects. This equipment must be regularly accessed by technicians for maintenance, adjustment, and replacement operations. The overhead positioning of such equipment, often at heights of 20 feet or more above the stage or floor level, creates significant challenges for safe and efficient access.

Current access methods primarily rely on ladders, personnel lifts, or scissor lifts. Ladders present the most significant safety hazard due to the inherent risk of falls, particularly when technicians must carry tools or equipment while climbing. Falls from ladders remain one of the leading causes of workplace injuries and fatalities in the entertainment industry. Personnel lifts and scissor lifts, while safer than ladders, are not universally available at all facilities. Many venues, particularly older theaters or smaller performance spaces, lack the budget or storage space for such equipment. Even when available, these lifts require time to position and stabilize, significantly increasing the time required for routine maintenance tasks.

The structural systems used to support overhead equipment present additional challenges. Traditional aluminum truss structures, which form the backbone of most overhead rigging systems, rely on welded connections. The welding process creates heat-affected zones in aluminum that substantially reduce the material's strength compared to its unwelded state. This metallurgical weakness at connection points limits the load-bearing capacity of the overall structure and necessitates over-engineering to maintain adequate safety factors.

Existing hoist systems suffer from inflexibility in their configurations. Once installed, the positions of hoist modules are fixed and cannot be adjusted to accommodate different performance requirements or venue reconfigurations. This limitation forces venues to either accept suboptimal equipment positioning or invest in entirely new systems when their needs change. The inability to reconfigure hoist positions also prevents venues from sharing or repurposing equipment between different spaces.

Previous attempts to address these access challenges have focused on roof-mounted hoist systems where the lifting machinery remains permanently affixed to the building structure while only moving the payload. These solutions impose significant limitations on implementation. First, they require specific roof construction capable of supporting the concentrated loads from the hoisting machinery, which many existing facilities cannot provide without extensive structural modifications. Second, the overhead positioning of motors and control systems requires dedicated space in ceiling voids or attic areas, which is often unavailable in facilities with limited vertical clearance.

Furthermore, roof-mounted systems merely relocate rather than eliminate the access problem. The motors, gearboxes, and control systems in these overhead installations require periodic maintenance, inspection, and eventual replacement. Accessing this machinery necessitates lifts with even greater vertical reach than would be required for the stage equipment itself, as technicians must work above the already elevated equipment. This requirement for specialized, high-reach access equipment further limits the practicality of roof-mounted solutions for many facilities.

The fixed nature of traditional hoist system configurations prevents venues from adapting to changing performance requirements. Different productions may require equipment at varying positions across the performance space, but conventional systems lock venues into predetermined hoist locations established during initial installation. This inflexibility forces compromises in production design or requires costly system replacements when venue needs evolve.

### SUMMARY

The present invention provides a revolutionary modular hoist system that fundamentally transforms how entertainment equipment is installed, operated, and maintained in performance venues. The system delivers unprecedented flexibility, safety, and operational efficiency through its innovative self-climbing design and completely weld-free construction methodology.

The hoist system in accordance with the present invention offers substantial safety improvements by eliminating the need for personnel to work at dangerous heights. Traditional fixed overhead hoist systems require technicians to climb ladders or use aerial lifts for routine inspection and maintenance, creating significant fall hazards. The present self-climbing system travels with the load, automatically lowering the hoisting machinery to ground level with every operation cycle, where it can be safely inspected and serviced without any climbing equipment.

The hoist system achieves superior structural integrity through its pioneering weld-free construction. Unlike conventional aluminum truss systems that suffer from heat-affected zones at welded joints—reducing strength by up to 50%—the present invention maintains full material strength throughout by utilizing mechanical connections exclusively. This includes innovative snap ring assemblies, splined anti-rotation connections, and compression fittings that provide secure, high-strength joints while preserving the aluminum's original mechanical properties.

The modular design delivers exceptional versatility and economic benefits. Venue operators can reconfigure the same system for multiple applications by simply changing the bottom chord configuration—switching between round pipe for lighting, T-slot extrusions for scenic elements, Unistrut for general rigging, curtain track for soft goods, specialized track lighting rails, or the like. This eliminates the need to purchase separate dedicated systems for each application, significantly reducing capital equipment costs.

The field-adjustable spanning capability allows the hoist system to accommodate varying venue geometries without custom fabrication. Users can add or remove intermediate hoist modules as load requirements change, optimizing capacity and cost for each specific application. This modularity extends equipment lifespan by allowing component replacement rather than complete system replacement.

The hoist system can be disassembled, thereby revolutionizing system logistics. Each module weighs approximately 100 pounds and is smaller than a standard suitcase, while chord sections ship as compact linear elements. This enables cost-effective transportation using standard shipping methods rather than specialized freight, and allows installation in venues with limited access routes that cannot accommodate pre-assembled trusses.

The mechanical assembly process eliminates the need for certified welders or specialized fabrication facilities. Venue personnel can assemble, modify, or reconfigure systems using basic hand tools, reducing installation time and labor costs while enabling on-site adaptability to changing requirements.

The hoist system achieves exceptional structural performance with minimal deflection thereby creating virtually imperceptible bending that maintains clean architectural lines. This aesthetic consideration is crucial for modern performance venues where exposed technical systems must complement architectural design.

The hoist system may include an integrated cable management system that provides clean, organized routing of power and control conductors through pantograph assemblies that move seamlessly with the load. Strategic cutouts in support plates accommodate pantograph arm movement without compromising structural integrity, while internal wiring capability in certain bottom chord configurations further enhances visual cleanliness.

The hoist system specifically addresses the demanding requirements of contemporary entertainment technology. For LED video wall installations, a perforated square tube bottom chord option enables precise vertical adjustment through threaded fasteners, ensuring perfect pixel alignment across multiple panels. The synchronized drive shaft system guarantees uniform movement across all hoist points, preventing the racking or tilting that can damage expensive video equipment.

The three-chord truss design (two top, one bottom) provides superior torsional rigidity compared to traditional two-chord systems, which is advantageous for maintaining alignment of sensitive equipment like moving lights and video projectors. Support plates spaced at predetermined intervals ensure consistent load distribution and minimize localized stress concentrations.

The self-lowering capability transforms maintenance economics by eliminating aerial work platform rental costs and reducing maintenance time. Technicians can perform all inspection and service tasks at ground level during normal operation cycles, improving maintenance compliance and equipment reliability.

The modular construction of the hoist system enables targeted component replacement, extending system lifespan indefinitely. Individual hoist modules, drive shafts, or chord sections can be replaced without affecting the remaining system, contrasting sharply with welded trusses that often require complete replacement when localized damage occurs.

In summary, the hoist system in accordance with the present invention provides a transformative solution that enhances safety, reduces costs, improves flexibility, and delivers superior performance compared to traditional entertainment hoisting systems. Its innovative design principles address longstanding industry challenges while providing a platform for future technological advancement in entertainment venue infrastructure.

### BRIEF DESCRIPTION OF THE DRAWINGS

The accompanying drawings illustrate several embodiments and, together with the description, serve to explain the principles of the invention according to the embodiments. It will be appreciated by one skilled in the art that the particular arrangements illustrated in the drawings are merely exemplary and are not to be considered as limiting of the scope of the invention or the claims herein in any way.

FIGS. 1-3 are perspective views of a modular hoist system in three different configurations, in accordance with an aspect of the present invention.

FIG. 4 is a perspective view of a powered hoist module, in accordance with an aspect of the present invention.

FIG. 5 is a perspective view of a non-powered hoist module, in accordance with an aspect of the present invention.

FIGS. 6A and 6B are perspective views of two examples of cable drum assemblies, in accordance with an aspect of the present invention.

FIGS. 7A-7C are front perspective views of support plates having different interchangeable mounting members removably coupled thereto, in accordance with an aspect of the present invention.

FIG. 8 illustrates examples of interchangeable mounting members and coordinating bottom chord members that may be used in the modular hoist system, in accordance with an aspect of the present invention.

FIG. 9 is a perspective view of a portion of a modular hoist system that includes a pantograph system coupled to a plurality of support plates,, in accordance with an aspect of the present invention.

FIGS. 10A and 10B are perspective views of two examples of the connection mechanism for coupling tubular members and chords to a drum support plate.

### DETAILED DESCRIPTION

The present invention is for a modular self-climbing hoist that includes a plurality of hoist modules coupled to a horizontal truss. A plurality of support plates are removably coupled to the horizontal truss at predetermined intervals. The invention is described by reference to various elements herein. It should be noted, however, that although the various elements of the inventive apparatus are described separately below, the elements need not necessarily be separate. The various embodiments may be interconnected and may be cut out of a singular block or mold. The variety of different ways of forming an inventive apparatus, in accordance with the disclosure herein, may be varied without departing from the scope of the invention.

One or more different embodiments may be described in the present application. Further, for one or more of the embodiments described herein, numerous alternative arrangements may be described; it should be appreciated that these are presented for illustrative purposes only and are not limiting of the embodiments contained herein or the claims presented herein in any way. One or more of the arrangements may be widely applicable to numerous embodiments, as may be readily apparent from the disclosure. In general, arrangements are described in sufficient detail to enable those skilled in the art to practice one or more of the embodiments, and it should be appreciated that other arrangements may be utilized and that structural, logical, software, electrical and other changes may be made without departing from the scope of the embodiments. Particular features of one or more of the embodiments described herein may be described with reference to one or more particular embodiments or figures that form a part of the present disclosure, and in which are shown, by way of illustration, specific arrangements of one or more of the aspects. It should be appreciated, however, that such features are not limited to usage in the one or more particular embodiments or figures with reference to which they are described. The present disclosure is neither a literal description of all arrangements of one or more of the embodiments nor a listing of features of one or more of the embodiments that must be present in all arrangements.

Headings of sections provided in this patent application and the title of this patent application are for convenience only and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible embodiments and in order to more fully illustrate one or more embodiments. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the embodiments, and does not imply that the illustrated process is preferred. Also, steps are generally described once per aspect, but this does not mean they must occur once, or that they may only occur once each time a process, method, or algorithm is carried out or executed. Some steps may be omitted in some embodiments or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other embodiments need not include the device itself.

Techniques and mechanisms described or referenced herein will sometimes be described in singular form for clarity. However, it should be appreciated that particular embodiments may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various embodiments in which, for example, functions may be executed out of order from that shown or discussed, including substantially concurrently or in reverse order, depending on the functionality involved, as would be understood by those having ordinary skill in the art.

The detailed description set forth herein in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

### Apparatus Overview

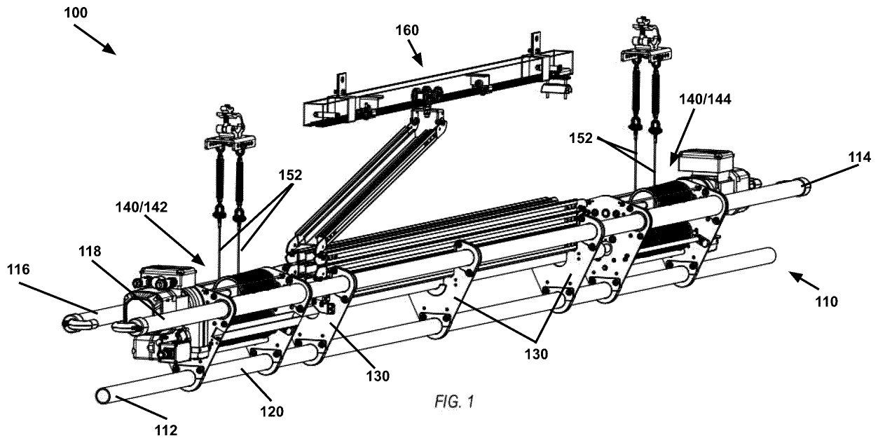

The present invention relates to a modular self-climbing hoist system 100 for lifting and lowering equipment relative to an overhead structure in a venue. Examples of such systems 100 are shown in FIGS. 1-3. The system 100 includes a horizontal truss assembly 110 extending between a first end 112 and a second end 114, with the truss assembly 110 including at least three parallel chords: a first top chord 116, a second top chord 118, and a third bottom chord 120. The chords 116, 118, 120 extend longitudinally along the length of the truss assembly 110 and are maintained in their parallel relationship by a plurality of support plates 130 distributed at intervals along the truss length. A plurality of hoist modules 140 are mounted to the truss assembly 110. The chords 116, 118, 120, support plates 130, and hoist modules 140 are removably coupled together so that the hoist system 100 can be customized based on the needs of the user. The system 100 is not limited to having three chords, and may include four or more parallel chords.

The support plates 130 are structural members that mechanically connect to all three chords 116, 118, 120 through removable mechanical fasteners. Each support plate 130 includes apertures or mounting features that facilitate removable connection to the chords 116, 118, 120. The first top chord 116 connects to an upper portion of each support plate 130 through mechanical fasteners such as bolts, pins, or clamps. Similarly, the second top chord 118 connects to another upper portion of each support plate 130, with the two top chords 116, 118 typically positioned symmetrically about a vertical plane through the truss centerline. The third bottom chord 120 connects to a lower portion of each support plate 130, completing the triangulated structural geometry of the truss assembly 110.

A primary hoist module 142 is mounted to the first end 112 of the horizontal truss assembly 110. This primary hoist module 142 includes a gearbox housing containing reduction gearing, with the gearbox mechanically connected to the truss assembly 110 through bolted or clamped connections to the chord ends and/or an end support plate. A motor with an integral disc brake attaches to the gearbox housing and provides rotational input to the reduction gearing. The output of the gearbox drives a cable drum having a twin helix groove pattern formed on its outer surface. The twin helix configuration provides two separate helical paths for wire rope, with the helixes oriented in opposite directions to balance lateral forces during operation.

Wire rope lift lines 152 wind around the cable drum, with each lift line 152 extending upward from the drum to attachment points on an overhead structure. The lift lines 152 support the entire weight of the self-climbing hoist system 100 and any attached payload. As the motor rotates the drum through the gearbox, the lift lines either wind onto or pay off from the drum, causing the entire assembly to climb up or down along the lift lines.

A secondary hoist module 144 is mounted to the second end 114 of the horizontal truss assembly 110, opposite the primary hoist module 142. The secondary hoist module 144 includes similar components to the primary module 142, including a gearbox housing, cable drum with twin helix grooves, and lift lines 152. However, the secondary hoist module 144 incorporates a position encoder connected to monitor drum rotation and thereby track the vertical position of the system 100. The secondary hoist module 144 receives electrical power only when the primary hoist module 142 is activated, ensuring synchronized operation.

The primary and secondary hoist modules 142, 144 connect through a drive shaft system that transmits torque between the hoist modules 142, 144. The drive shaft extends through or alongside the horizontal truss assembly 110, with mechanical couplings at each end connecting to the respective gearbox outputs. These couplings employ splined connections, where matching male and female splined surfaces engage to transmit torque while allowing for minor axial movement during assembly. Snap rings or similar retaining devices secure the splined connections against separation while permitting easy disassembly.

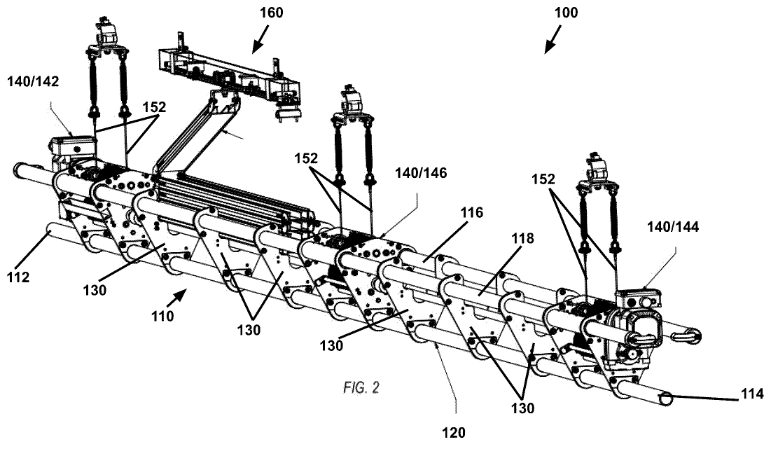

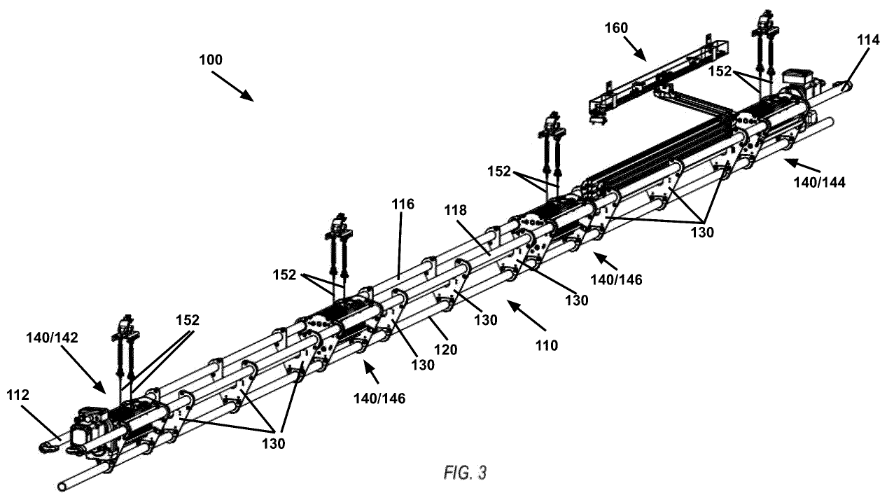

In some examples, such as those depicted in FIGS. 2 and 3, the hoist system 100 includes intermediate non-powered hoist modules 146, which mount to the horizontal truss assembly 110 at positions between the primary and secondary modules 142, 144. Each intermediate module 146 includes a cable drum similar to those in the powered modules 142, 144, with lift lines 152 extending to overhead attachment points. The drive shaft system extends through each intermediate module 146, with the shaft connecting to the drum through internal gearing or direct coupling. This arrangement ensures that all drums rotate synchronously, maintaining level operation of the truss assembly 110 during vertical movement.

The mechanical connections throughout the system 100 employ various non-welded joining methods. Splined engagements, as described for the drive shaft couplings, provide torque transmission capability while allowing assembly and disassembly. Set screws threaded into tapped holes provide adjustable positioning and locking of components such as collars on shafts or the securement of modular components to the truss chords 116, 118, 120. Compression fittings, including split clamps and collet-style connectors, grip cylindrical surfaces to create rigid connections without permanent alteration of the joined components.

The third bottom chord 120 of the truss assembly 110 is removably coupled to the support plates 130 and the hoist modules 140, thereby permitting interchangeability of different bottom chord configurations. The bottom chord 120 connects to the lower portions of the support plates 130 through mechanical fasteners that allow removal and replacement of the entire bottom chord 120 as a unit. Various bottom chord configurations can be substituted depending on the application requirements.

One configuration employs a round pipe as the bottom chord, providing attachment points for theatrical scenery through standard theatrical clamps and fittings. Another configuration utilizes an aluminum extrusion with T-slot profiles running along its length, enabling the attachment of various hardware using T-nuts that slide within the slots. A further configuration incorporates a Unistrut-style channel with inward-facing lips, compatible with standard channel nuts and spring clips for mounting rolling curtain tracks or similar equipment. Yet another configuration features an integrated curtain track or track lighting rail as the bottom chord itself.

The drive shaft system extending between hoist modules 140 includes modular shaft sections that connect through mechanical couplings. Each shaft section includes splined or keyed ends that engage with corresponding features in the couplings. The couplings may incorporate flexible elements such as elastomeric inserts to accommodate minor misalignments while maintaining torsional rigidity. Intermediate support bearings mount to the truss assembly 110 at intervals along the drive shaft length to prevent excessive deflection under torsional loads.

The gearboxes in the hoist modules 140 feature modular construction with removable cover plates secured by bolts rather than welded joints. This design allows field service and component replacement without cutting or re-welding. Internal components such as gears, bearings, and shafts install through the removable covers, with precise positioning maintained by machined housing features rather than welded brackets.

The cable drums employ a modular hub design where the drum body attaches to a central hub through mechanical fasteners. This arrangement permits drum replacement or reconfiguration without replacing the entire hoist module. The twin helix grooves may be machined directly into the drum body or formed by a helical insert mechanically attached to a cylindrical drum shell.

Electrical components including the motor, brake, and encoder mount to their respective hoist modules 140 through bolted flanges or adjustable mounting brackets. Electrical connections utilize plug-and-socket connectors rather than permanent wiring terminations, facilitating module replacement and system reconfiguration. A control system coordinates operation of the primary and secondary hoist modules 142, 144, with electrical interlocks preventing operation unless both hoist modules 142, 144 are properly connected and powered.

The modular construction enables transportation of the system 100 as separate components that fit within standard shipping containers or truck beds. Assembly at the venue requires only hand tools and lifting equipment appropriate for the individual module weights. The mechanical connections align through visual indicators, physical stops, or keyed features that prevent incorrect assembly.

During operation, the single motor in the primary hoist module 142 drives all drums through the mechanical drive shaft system. This arrangement ensures perfect synchronization without relying on electronic speed matching or position feedback systems. The twin disc brakes (one in the primary hoist module 142 and one in the secondary hoist module 144) provide redundant holding capacity when the system 100 is stationary. In the event of primary motor failure, the secondary module's brake prevents uncontrolled descent while the drive shaft connection ensures both ends 112, 114 of the truss 110 remain level.

The system 100 accommodates various spans by adding or removing intermediate hoist modules 146 and corresponding truss sections. The modular chord design allows field adjustment of truss length through the addition or removal of chord segments and support plates 130. Drive shaft sections similarly add or remove to match the truss length, with the splined couplings accommodating the length variations.

The hoist system 100 operates within performance venues and interfaces with existing overhead structural systems commonly found in theaters, concert halls, and similar facilities. The hoist system 100 interacts with the building's structural steel framework through wire rope lift lines 152 that extend from cable drums housed within each hoist module 140 to designated attachment points on the overhead structure. This interface allows the system 100 to be suspended and operated within the vertical space between the overhead structure and the stage floor.

During installation, the system components interact through mechanical connections that form a unified assembly. The top chords 116, 118 interface with the hoist modules 140 by passing through tubular members integrated into each module 140, with alternative connection methods utilizing set screws or compression fittings to secure the chords 116, 118 in position. Support plates 130 mount at predetermined intervals along the chords 116, 118, 120, providing structural reinforcement and load distribution points. Drive shaft segments mechanically link adjacent hoist modules, enabling synchronized operation across the entire system length.

The assembled system 100 interfaces with various types of stage equipment and production elements. The truss structure 110 provides mounting points for lighting fixtures, audio equipment, video panels, curtains, and scenic elements. A pantograph system 160 maintains continuous electrical and control connections between the stationary building infrastructure and the movable hoist system 100, accommodating vertical movement while supplying power to the motors and any equipment mounted on the truss 110. This electrical interface enables both the operation of the hoist motors and the functionality of production equipment without requiring separate power distribution systems.

The hoist system 100 interacts with human operators through remote control interfaces that allow stage technicians to position the hoist at various working heights. When lowered to floor level, the hoist system 100 provides accessible mounting points for equipment installation and maintenance. The modular design accommodates different building configurations through the selection of appropriate chord lengths and hoist module spacing, allowing the system to adapt to varying structural bay widths and load requirements found in different venues.

### Horizontal Truss Assembly

The horizontal truss assembly 110 comprises a structural framework configured to support loads while maintaining minimal deflection under operational conditions. The three elongated chord members 116, 118, 120 arranged in a triangulated configuration. Two top chords 116, 118 are positioned in a parallel relationship at an upper elevation and a single bottom chord 120 is positioned at a lower elevation relative to the top chords 116, 118. The distance between the lower elevation and the upper elevation is proportional to the distance between adjacent support plates 130, as discussed in more detail below. The truss assembly 110 is not limited to three chords, and may include four or more chords. For example, the truss assembly 110 may include four chords arranged in a square or rectangular configuration.

A plurality of support plates 130 are mechanically coupled to the chord members 116, 118, 120 at predetermined intervals along the length of the horizontal truss assembly 110. These support plates 130 may be spaced at distances not exceeding 3 feet, with the spacing being proportional to the vertical separation distance between the bottom chord 120 and the top chords 116, 118. In particular embodiments, the spacing between adjacent support plates 130 is between 2 to 4 times the vertical distance separating the bottom chord 120 from the top chords 116, 118. This proportional spacing arrangement provides structural rigidity to the assembly 110 while optimizing material usage.

The support plates 130 mechanically interconnect all three chords 116, 118, 120 through non-welded attachment mechanisms, which may include threaded fasteners, splined engagements, snap-ring retainers, clamping members, or combinations thereof. This mechanical attachment configuration enables the horizontal truss assembly 110 to be disassembled into individual chord segments for transport and subsequently reassembled in various configurations.

The chord members 116, 118, 120 of the horizontal truss assembly 110 are configured to interconnect and/or splice at designated hoist module locations. In certain embodiments, the top chords 116, 118 extend continuously through tubular members integrated within the hoist modules 140. In alternative embodiments, the top chords 116, 118 are removably attached to the hoist modules 140 through mechanical coupling mechanisms.

The horizontal truss assembly 110 is configured to accommodate field-selectable chord lengths, enabling the overall span of the assembly 110 to be adjusted between different dimensions, while utilizing a common set of hoist modules 140. This modularity provides flexibility in adapting the horizontal truss assembly 110 to various installation requirements.

The top chords 116, 118 of the horizontal truss assembly 110 may be fabricated from aluminum or steel materials. When constructed from aluminum, the top chords 116, 118 may comprise extruded aluminum sections, including configurations such as nominal 1.5-inch schedule 40 aluminum pipe. Steel construction may be employed when enhanced strength characteristics are required for particular loading conditions.

The bottom chord 120 of the assembly 110 may be configured in various cross-sectional profiles, including round tube, square tube, rectangular tube, channel, strut, or track configurations, with the selection based on specific load attachment requirements and structural performance criteria.

### Primary Hoist Module

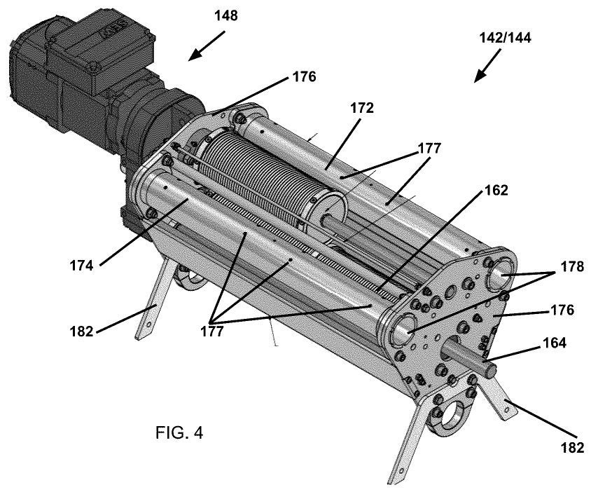

The primary hoist module 142, depicted in more detail in FIG. 4, comprises a motor-driven lifting mechanism that provides controlled vertical movement of loads. The primary hoist module 142 includes a motor 148 operatively connected to a gearbox, which transmits rotational power to a shaft 164 coupled to a cable drum 162. The cable drum 162 incorporates a twin helix configuration wherein grooves are machined to wind from both left and right sides toward a center position of the drum 162. Two wire rope cables 152 (shown in FIGS. 1-3) are secured to the drum, with one cable being diverted by an idler drum having an opposing helix configuration. This arrangement causes the lift line to mirror across the drum centerline, thereby providing balanced loading characteristics during hoisting operations. However, the cable drum 162 is not limited to a twin helix configuration and it will be well understood that other cable winding arrangements may be used in the system 100.

The gearbox of the primary hoist module 142 drives a rotary cam limit switch assembly that establishes travel limits in both upward and downward directions. The rotary cam limit switch assembly further includes additional cam elements that define safety overtravel limits beyond the normal operational travel limits. A motor brake is incorporated into the primary hoist module 142, wherein the brake is spring-applied upon removal of electrical power, thereby providing fail-safe operation that prevents uncontrolled descent of loads.

The shaft 164 extends through the cable drum 162 and is supported by a ball bearing assembly. The shaft 164 continues beyond the cable drum 162 to a coupling mechanism configured to connect with drive shafts, thereby enabling mechanical interconnection with additional modules in a multi-module system configuration.

The primary hoist module 142 incorporates roller snubbers mounted to the cable drum 162 to facilitate orderly cable winding. These roller snubbers comprise polyurethane members reinforced by steel axle rods that maintain contact with the wire rope during operation. Spring-loaded anti-friction bearings apply predetermined tension to the roller snubbers, maintaining consistent cable positioning during winding and unwinding operations.

A slack detection system is integrated into the primary hoist module 142. The slack detection system includes a charged bar arrangement that monitors wire rope tension. When a section of wire rope becomes slack due to an obstruction or other operational anomaly, the charged bar contacts the lift line, creating an electrical ground condition. This ground condition is detected by a sensor that communicates with the control system to initiate a stop command.

The structural configuration of the primary hoist module 142 includes first and second top tubular members 172, 174 configured to receive top chord members 116, 118 therethrough or to provide attachment points for such chord members 116, 118. The tubular members 172, 174 incorporate apertures 177 distributed along their lengths. The apertures are configured to receive set screws for securing chord elements 116, 118 in predetermined positions. The drum shaft 164 and the tubular members 172, 174 are supported by drum support plates 176 that feature openings 178 with splined configurations. These splined openings 178 engage with correspondingly splined ends of the tubular members 172, 174 to provide secure mechanical connection.

Detachable shipping legs 182 are removably coupled to the primary hoist module 142 to provide support during assembly operations. These shipping legs 182 are removed following suspension of the primary hoist module 142 in its operational position.

### Secondary Hoist Module

The secondary hoist module 144 is substantially similar to the primary hoist module 142 and comprises a mechanical assembly that operates in conjunction with the primary hoist module 142 through mechanical interconnection via drive shaft components. The secondary hoist module 144 includes a gearbox having an output shaft coupled to an encoder that generates position data signals. The encoder may produce incremental position signals or coded position data that is transmitted to a motor control system for monitoring operational parameters including current position and running status.

The secondary hoist module 144 incorporates a mechanical timing link established through the hoist system's drive shaft arrangement. This mechanical interconnection creates a redundant load path between the primary and secondary modules 142, 144. When brake components in either module experience operational failure, the mechanical coupling through the drive shafts prevents unintended lowering of the hoist load when power is not being supplied to the system 100.

The secondary hoist module 144 includes first and second top tubular members 172, 174 configured with splined ends and flanges. These tubular members 172, 174 facilitate connection to drum support plates 176 through mechanical engagement. The tubular members 172, 174 incorporate apertures 177 distributed along their lengths. The apertures are configured to receive set screws for securing chord elements 116, 118 in predetermined positions. The secondary hoist module 144 further includes detachable shipping legs 182 that may be removed following installation.

Mechanical coupling between the secondary hoist module 144 and drive shaft portions is achieved through removable coupling assemblies. These coupling assemblies enable disconnection and removal of module components without requiring cutting or welding operations. The structural connections employ removable mechanical connection elements including, but not limited to, threaded fasteners, splined engagement interfaces, snap-ring retainers, and clamping members.

### Intermediate Non-Powered Hoist Module

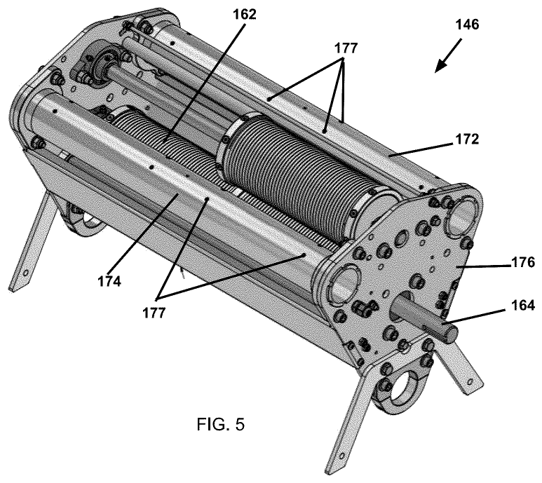

The intermediate non-powered hoist module 146, depicted in more detail in FIG. 5, comprises a cable drum 162 rotatably mounted on a drum shaft 164, wherein the drum shaft 164 includes coupling interfaces at both ends configured to mechanically connect with adjacent drive shafts. The intermediate hoist module 146 functions as a torque transmission element within the modular hoist system 100, receiving rotational input from an upstream drive shaft and transmitting said rotation to a downstream drive shaft while simultaneously operating its own cable drum 162.

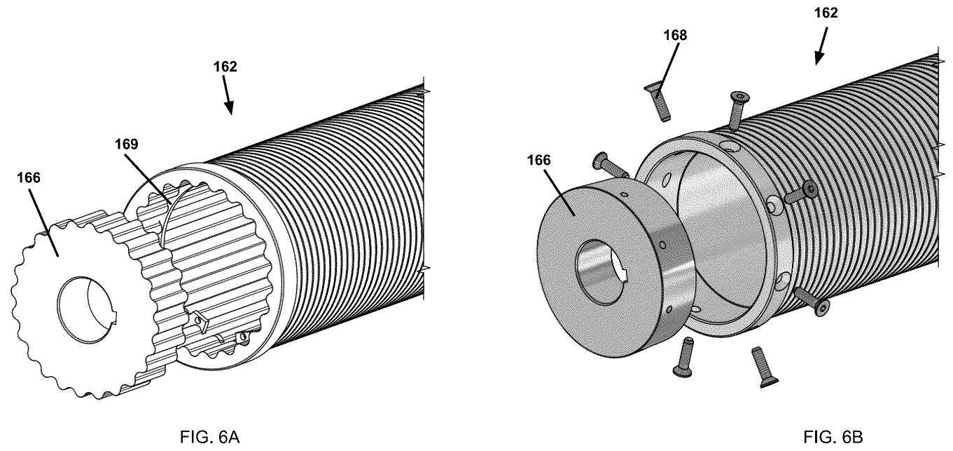

As shown in FIGS. 6A and 6B, the cable drum assembly 162 incorporates a hub member 166 that interfaces with the drum shaft 164 and transmits torque to the drum perimeter through mechanical engagement features. In one embodiment, shown in FIG. 6A, the hub-to-drum interface comprises fluted splines formed in the drum material, wherein the splines mate with corresponding features on the hub member 166. For example, the drum 162 may include precision-machined aluminum extrusions featuring integral spline profiles formed during the extrusion process. These extruded splines mate with laser-cut spline features on the hub member 166, providing enhanced torque transmission capacity suitable for high-volume production applications. In an alternative example, shown in FIG. 6B, the hub member 166 comprises a conical configuration secured to the drum 162 via countersunk fasteners 168 distributed circumferentially around the hub perimeter. The drum assembly may further include retention features such as snap ring grooves machined into the drum body to axially constrain the hub member 166 using a snap ring 169. The selection between conical hub configurations with mechanical fasteners and splined interfaces depends on production volume requirements and manufacturing capabilities.

Similar to the powered hoist modules 142, 144, the intermediate hoist module 146, as shown in FIG. 5, includes top tubular members 172, 174 and drum support plates 176 configured for removable attachment to the chords 116, 118, 120 of the hoist system framework 110. The attachment mechanism enables field reconfiguration without requiring permanent joining methods such as welding. For example, the tubular members 172, 174 includes apertures 177 along the lengths thereof so that set screws may be used to hold the chords 116, 118 in place relative to the tubular members 172, 174.

During operation, the intermediate hoist module 146 receives torque input through its upstream coupling from either a primary powered hoist module 142 or another intermediate module 146. The torque propagates through the drum shaft 164 to the downstream coupling, thereby maintaining mechanical synchronization across multiple hoist modules 140 in the system 100. The cable drum 162 rotates in unison with the drum shaft 164, enabling coordinated lifting operations across distributed lift points.

In certain system configurations where lift points are positioned in close proximity, the intermediate hoist module 146 may be omitted, with the system 100 operating using only primary and secondary powered hoist modules, 142, 144, as shown in the exemplary system in FIG. 1. The modular architecture accommodates various combinations of powered and non-powered hoist modules 140 to optimize system configuration for specific lifting requirements while maintaining mechanical synchronization through the continuous driveline.

### Support Plates

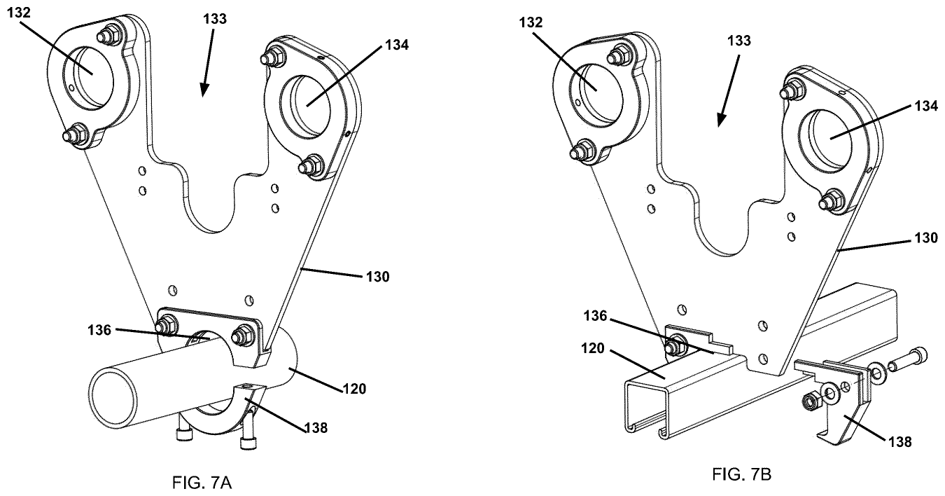

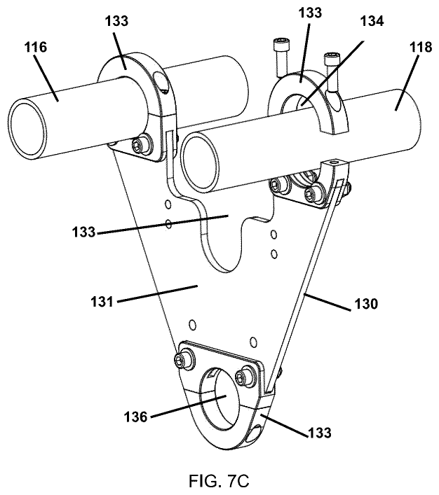

The support plates 130, shown in more detail in FIGS. 7A-7C, comprise structural members that interconnect and maintain the spatial relationship between the top chords 116, 118 and bottom chord 120 of the truss assembly 110. Each support plate 130 includes a first top opening 132 configured for removable coupling to the first top chord 116, a second top opening 134 configured for removable coupling to the second top chord 118, and a third bottom opening 136 configured for removable coupling to the third bottom chord 120. The support plates 130 are distributed along the length of the truss assembly 110 at predetermined intervals.

The spacing intervals between adjacent support plates 130 may be proportional to the vertical distance between the third bottom chord 120 and the first and second top chords 116, 118, with the proportionality factor typically ranging from 2 to 4 times said vertical distance. This mathematical relationship between the support plate spacing and chord separation distance provides optimized structural performance while minimizing material usage and deflection characteristics of the assembled truss.

In certain embodiments, at least a portion of the support plates 130 incorporate cutouts 133 dimensioned and positioned to permit movement of pantograph arms therethrough while maintaining structural performance of the support plate 130. Finite element analysis demonstrates that stress distributions follow predictable paths around these cutouts 133 without compromising the structural integrity of the support plates 130 or the overall truss assembly 110.

The support plates 130 facilitate removable attachment of the third bottom chord 120 through the third bottom opening 136. A plurality of interchangeable mounting members 138 may be selectively attached to the support plates 130 to accommodate different bottom-chord configurations. The interface between the support plates 130 and the interchangeable mounting members 138 permits field replacement of the mounting members without inducing permanent deformation in either the support plate 130 or the third bottom chord 120. For example, the support plate 130 shown in FIG. 7A has a mounting member 138 attached thereto that accommodates a bottom chord 120 having a round profile, while the mounting member 138 shown in FIG. 7B accommodates a bottom chord 120 having a square profile.

In another embodiment, shown in FIG. 7C, the support plates 130 include a base plate 131 and a plurality of clamping members 133. The clamping members 133 are removably attached to the base plate 131 through removable fasteners, such as bolts, screws, or similar mechanical fastening devices. When assembled, the clamping members 133 cooperate with the base plate 131 to form the first top opening 132, second top opening 134, and third bottom opening 136. This configuration permits disassembly of the support plate 130 by removing the fasteners and separating the clamping members 133 from the base plate 131.

Each clamping member 133 includes two or more collar segments that surround the chord member 116, 118, 120. Bolts pass through corresponding openings in the collar segments, drawing them together to create clamping force on the chord 116, 118, 120. This configuration enables rapid field assembly as the collar segments can be positioned around the chord 116, 118, 120 without requiring chord end access.

### Drive Shaft Assembly

The drive shaft assembly comprises a plurality of interconnected shaft segments that extend between and mechanically couple adjacent hoist modules 140 in the modular truss hoist system 100. Each shaft segment transmits rotational torque from a primary hoist module motor to the cable drums 162 of connected hoist modules 140, thereby establishing synchronized rotation across multiple lift points.

The drive shaft assembly includes shaft segments having predetermined lengths corresponding to selectable chord lengths of the truss system 110. When assembled, the shaft segments form a continuous mechanical linkage extending through multiple hoist modules 140. The drive shaft assembly transmits torque through mechanical connections at each hoist module 140, causing the cable drums 162 of all connected hoist modules 140 to rotate at identical angular velocities. This synchronized rotation ensures that lift lines 152 wind and unwind at equal rates, maintaining the supported truss 110 in a level orientation during raising and lowering operations.

In operation, when the primary hoist module motor generates rotational output, torque is transmitted through the drive shaft assembly via shear forces in the mechanical connections. The shaft segments incorporate keyways that engage with corresponding hub connections at each hoist module 140. Fasteners disposed around the perimeter of these connections transmit the rotational forces through shear loading. The mechanical timing established by the drive shaft assembly eliminates the need for electronic synchronization between hoist modules 140 while providing positive mechanical coordination of lift line movement.

The drive shaft assembly incorporates removable couplings that facilitate reconfiguration of the system for different span lengths. At least one hoist module 140 includes a removable coupling arrangement that permits extraction of the corresponding drive shaft portion without cutting or welding operations. In one embodiment, the removable coupling comprises a shaft extending through a cable drum 162, with at least one hub 166 keyed to the shaft. At least one snap ring is disposed in a groove formed in the shaft to retain the hub in axial position. Removal of the snap ring permits separation of the hub 166 and cable drum 162 from the shaft, enabling drive shaft extraction and replacement.

Alternative embodiments of the drive shaft assembly may incorporate solid shaft configurations for applications requiring maximum torsional rigidity or tubular shaft configurations for applications where weight reduction is desired. The couplings between shaft segments may be implemented as solid couplings for direct torque transmission or flexible couplings to accommodate minor misalignments between adjacent modules. Multi-component coupling assemblies may be employed to facilitate assembly and disassembly operations.

The drive shaft segments represent the primary components requiring modification when reconfiguring the system for different span lengths. All connections within the drive shaft assembly utilize removable mechanical fastening methods, enabling complete disassembly for transport and subsequent reassembly at different venues without specialized tools or permanent modifications to the components.

### Interchangeable Bottom Chord Mounting System

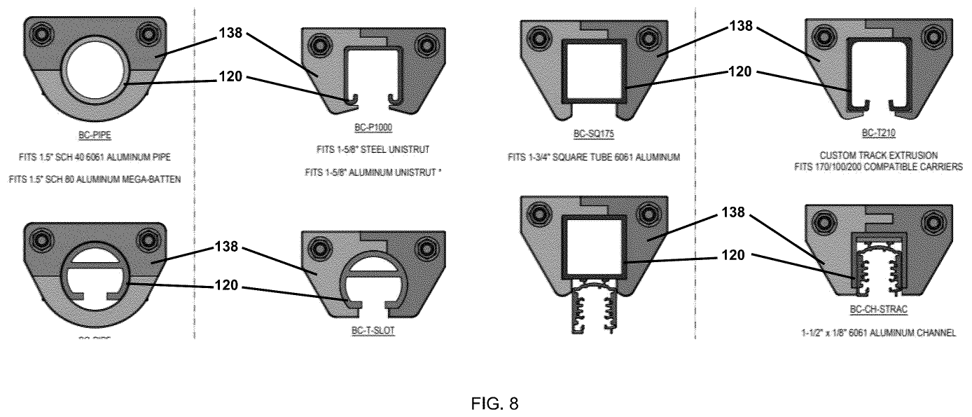

The interchangeable bottom chord mounting system comprises a modular attachment interface that enables selective coupling between the truss structure 110 and various types of bottom chord configurations, as shown in FIG. 8. The bottom chord mounting system includes a support plate 130 removably coupled to the truss framework and a plurality of interchangeable mounting members 138, each configured to engage with the support plate 130 through removable fasteners or bracket assemblies. FIG. 8 depicts examples of mounting members 138, which are configured as clamps having two portions that are coupled together with the bottom chord 120 positioned therebetween.

Each mounting member 138 of the bottom chord mounting system is configured with a specialized geometry corresponding to a particular bottom chord profile. In one embodiment, the mounting member 138 comprises a clamp mechanism with opposed gripping surfaces sized to secure round tubular members commonly used for scenery suspension. In another embodiment, the mounting member 138 includes a holder configuration with internal dimensions matching T-slot aluminum extrusions, wherein the holder permits sliding fasteners to translate along the extrusion length while maintaining secure engagement.

For applications requiring heavy-duty support, the bottom chord mounting system incorporates bracket-type mounting members 138 dimensioned to receive standard Unistrut channels measuring 1⅝ inches by 1⅝ inches. These brackets accommodate wheeled carrier assemblies that traverse along the channel length. The bottom chord mounting system also includes hanger-type mounting members compatible with theatrical curtain tracks.

In certain embodiments, the mounting members 138 of the bottom chord mounting system integrate holders for track lighting rails that incorporate both power and control conductors within the rail profile. The mounting members 138 attach to the support plate 130 through mechanical fasteners that permit field replacement without inducing permanent deformation in either the support plate or the associated bottom chord structure.

The third bottom chord configuration may comprise a structural channel or tube member providing primary bending resistance, with a secondary lighting or curtain track mounted thereto. This arrangement permits track replacement without compromising the structural capacity of the bottom chord assembly. For LED video wall installations, the structural member may be formed as a box tube with pre-drilled apertures accepting threaded fasteners, enabling precise vertical adjustment of suspension hardware.

Alternative bottom chord configurations compatible with the bottom chord mounting system include round tubes with integrated power distribution channels for stage lighting applications, such as those employed in MEGABATTEN® products. The bottom chord mounting system accommodates T-slot extrusions that receive sliding fasteners at arbitrary positions along their length. Track lighting rails may be integrated within structural aluminum channels or mounted beneath separate structural box tubes, providing architectural lighting capability with repositionable fixtures.

The interchangeable mounting members 138 of the bottom chord mounting system enable field conversion between different bottom chord types through a tool-based exchange process. The clamp mechanism opens to release one bottom chord type and accepts another without requiring modification to the support plate interface. This modularity permits adaptation of the truss system 110 to varying performance requirements while maintaining structural integrity and load-bearing capacity across all configurations.

### Pantograph Cable Management System

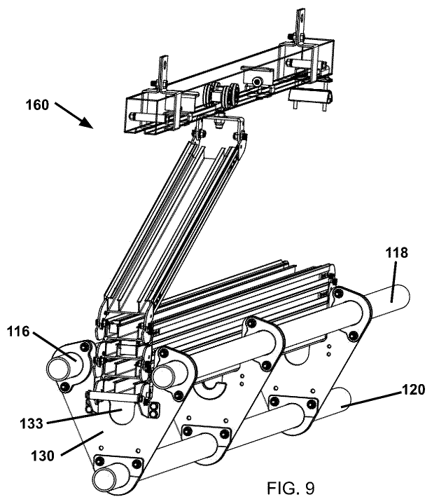

The pantograph cable management system 160, shown in more detail in FIG. 9, comprises a plurality of articulated arms configured to fold via hinges in a systematic and stacked arrangement. Each arm forms a tray structure that is either extruded or formed with compartments or troughs dimensioned to segregate electrical conductors by predetermined criteria including conductor size, voltage rating, or signal type. The compartmentalization facilitates separation of power conductors, control conductors, and signal conductors in accordance with applicable electrical codes.

In the stacked configuration, the trays nest within one another through the incorporation of guide elements that direct the folding motion. Sound reduction bumpers are positioned at contact points between adjacent trays to minimize acoustic emissions during operation. The pantograph cable management system 160 extends and compresses in coordination with vertical travel of an associated hoist mechanism, thereby maintaining continuous electrical connections between stationary power sources and the moving truss assembly.

The pantograph segments are configured with a standard length of six feet, with alternative configurations available in five-foot or four-foot lengths. Support plates 130 are spaced at intervals corresponding to half the pantograph segment length. Select support plates 130 incorporate cutouts 133 dimensioned to permit passage of the pantograph arms while maintaining structural integrity. Finite element analysis demonstrates that stress distribution follows around the cutout perimeters without creating failure points in the support plate structure.

The pantograph cable management system 160 employs a clamping mechanism within the trough structures to secure conductors in position. This clamping method prevents conductor displacement during extension and compression cycles of the pantograph assembly.

Alternative cable management configurations include cable reel systems, wherein conductors are wound onto rotating drums that pay out or retract cable as required. Swagged festoon systems employ carriers suspended from tracks to support looped conductor arrangements. Coiling cable systems utilize the natural spring properties of specialized cables that form helical coils during retraction. Coiling basket systems contain excess cable length within basket enclosures that accommodate the coiled conductors. Each alternative configuration provides electrification to the hoist mechanism with varying degrees of space efficiency, conductor organization, and operational characteristics.

### Chord-to-module Connection System

The chord-to-module connection system provides mechanical coupling between the continuous chord members 116, 118, 120 and individual hoist modules 140 in the modular truss assembly 110. The connection system facilitates both structural load transfer and enables selective positioning of hoist modules 140 along the chord length while maintaining the capability for complete disassembly and reassembly.

In a first embodiment, the connection system comprises first and second top tubular members 172, 174 integrated into each hoist module 140. The top chord members 116, 118 pass continuously through internal passages of these tubular members 172, 174. Set screws threadedly engage apertures 177 formed through the walls of the tubular members 172, 174, wherein tightening of the set screws causes their distal ends to bear against the outer surface of the chord tubes, thereby creating a clamping force that secures the hoist module 140 at a desired position along the chord. The set screws may be distributed circumferentially around the tubular members 172, 174 to provide uniform clamping pressure.

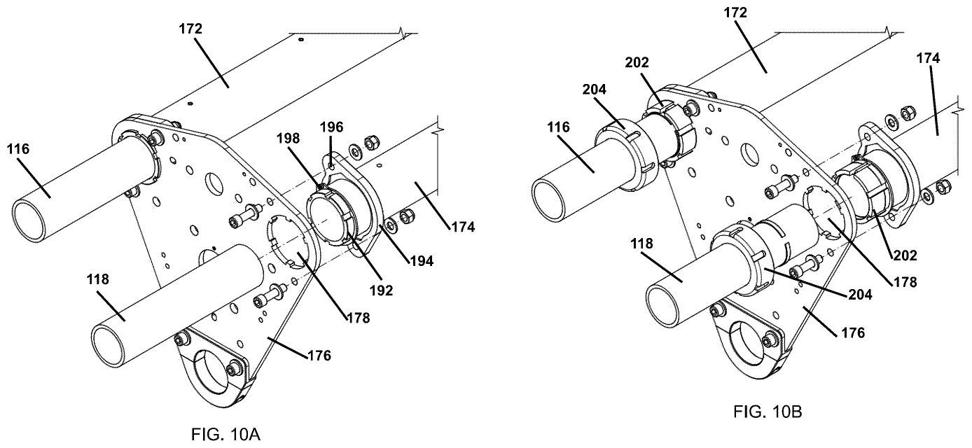

As shown in FIGS. 10A and 10B, the tubular members 172, 174 of the hoist modules 140 are coupled to the drum support plates 176 using a splined interface configuration. The tubular members 172, 174 terminate in splined ends 192 having external spline teeth. These splined ends 192 engage with correspondingly splined openings 178 formed in drum support plates 176. Flanges 194 are provided adjacent to the splined ends 192, with the flanges 194 containing bolt holes 196 that align with threaded apertures in the drum support plate surface. Bolts passing through the flange holes 196 and threading into the drum support plate apertures secure the connection. The spline engagement prevents relative rotation between components while transmitting torsional loads. Snap rings 198 seat within circumferential grooves formed in the splined ends 192, with the snap rings 198 bearing against machined relief surfaces to provide axial retention. The sliding interface between the snap ring 198 and relief surface accommodates assembly tolerances while maintaining structural rigidity.

In one embodiment, shown in FIG. 10B, chords 116, 118 may be coupled to the hoist modules 140 using a compression-based connection system. The tubular members 172, 174 of the hoist modules 140 feature threaded external ends 202 that receive compression nuts 204. Deformable ferrules or compression sleeves are positioned between the compression nut 204 and the chord member 116, 118. As the compression nut 204 is tightened, it drives the ferrule or sleeve to deform radially inward, creating a gripping force on the chord outer surface. This compression method generates enhanced anti-slippage resistance, making it particularly suitable for vertical truss orientations where gravitational loads act parallel to the chord axis. The compression connection can be released by loosening the compression nut 204, allowing the ferrule or sleeve to relax and enabling chord withdrawal.

All embodiments of the connection system utilize removable mechanical connections exclusively, specifically threaded fasteners, splined engagements, snap-ring retainers, and clamping members. This design philosophy enables complete disassembly of the truss structure into constituent components comprising separate chord segments 116, 118, 120, hoist modules 140, drive shaft segments, and support plates 130. The modular nature facilitates transport in standard shipping containers and enables field assembly without welding or permanent joining methods.

The connection system may incorporate position indexing features such as detents, graduated markings, or positive-engagement locating pins to facilitate repeatable positioning of hoist modules 140 along the chord length. Load-indicating washers or torque-limiting fasteners may be employed to ensure proper preload in bolted connections. Surface treatments such as anodizing, powder coating, or galvanizing may be applied to enhance corrosion resistance for outdoor applications.

### Lift Line and Cable Drum Assembly

The lift line and cable drum assembly comprises a twin helix drum configuration wherein grooves wind from opposing lateral positions toward a central region of each drum. Two wire rope cables are secured to each drum, with one cable being redirected through an idler drum incorporating an opposing helix configuration to establish a mirrored lift line arrangement across the drum centerline, thereby providing balanced hoisting operation.

During operation, a motor transmits rotational force through a gearbox and drive shaft system to rotate the drums 162. This rotation causes the wire ropes 152 to wind onto or unwind from the drum grooves in a controlled manner, effectuating vertical displacement of the truss assembly 110 relative to fixed attachment points on an overhead structure. The assembly incorporates roller snubbers comprising polyurethane members equipped with spring-loaded anti-friction bearings that maintain orderly cable winding and prevent cable overlap or misalignment during spooling operations.

The assembly further comprises a charged bar system for slack detection wherein an electrically charged bar is positioned adjacent to the wire rope path. Upon occurrence of slack conditions, such as when a truss section encounters an obstruction, the wire rope contacts the charged bar, creating an electrical ground condition that generates a signal to the control system to cease operation.

The drum construction employs a non-welded assembly methodology wherein aluminum hubs 166 interface with aluminum drums 162 through mechanical connections. Torque transmission occurs at the perimeter interface through various mechanical engagement means including flutes, splines, or shear fasteners. The wire rope entry, attachment, and hub clearance configurations incorporate proprietary geometries that facilitate smooth cable routing while maintaining structural integrity. The mechanical connections between hub and drum components eliminate heat-affected zones associated with welded joints.

Alternative embodiments of the assembly include various hub connection configurations. In one alternative, fluted splines are extruded directly into the drum material and engage with corresponding laser-cut splines on machined hubs, with the assembly retained by large-diameter snap rings, suitable for high-volume production applications. Another alternative employs conical hub geometry secured with countersunk screws for current production implementations. The hub-to-shaft interface may alternatively utilize keyway connections with snap ring retention or other keyed coupling arrangements to transmit rotational force while permitting axial assembly and disassembly.

### Additional Considerations

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present) , and both A and B are true (or present) .

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and/or a process associated with the disclosed principles herein. Thus, while particular embodiments and applications have been illustrated and described, it is to be understood that the disclosed embodiments are not limited to the precise construction and components disclosed herein. Various apparent modifications, changes and variations may be made in the arrangement, operation and details of the method and apparatus disclosed herein without departing from the spirit and scope defined in the appended claims.

What is claimed is:

1. A modular hoist system for lifting entertainment equipment in a place of assembly, comprising:
a horizontal truss extending between a first end and a second end and comprising at least three chords arranged parallel to each other to form a structural frame, the at least three chords including a first top chord, a second top chord, and a third bottom chord;
a plurality of hoist modules mounted to the horizontal truss, the plurality of hoist modules including a first hoist module at the first end of the horizontal truss, and a second hoist module at the second end of the horizontal truss;
one or more drive shafts extending along the horizontal truss and mechanically coupling the first hoist module and the second hoist module such that torque applied by a drive of the first hoist module is transmitted to the second hoist module;
a plurality of lift lines coupled to the plurality of hoist modules and configured so that the plurality of hoist modules raise and lower the horizontal truss and a payload mounted to the horizontal truss relative to an overhead structure, the plurality of hoist modules being configured to travel with the horizontal truss as a self-climbing assembly; and
a plurality of support plates spaced along the horizontal truss at predetermined intervals, each support plate being mechanically connected to the at least three chords.

2. The modular hoist system of claim 1, wherein the plurality of hoist modules further comprises at least one intermediate hoist module between the first hoist module and the second hoist module, each one of the hoist modules being removably connected to each of the at least three chords.

3. The modular hoist system of claim 1, wherein the third bottom chord is removably attachable to the plurality of support plates, and wherein a plurality of interchangeable mounting members are selectively attachable to the plurality of support plates to support different bottom-chord configurations including at least one of: a round tube for scenery, a round tube with integral power distribution for stage lighting, a T-slot extrusion, a Unistrut member, a curtain track, and a track-lighting rail.

4. The modular hoist system of claim 1, wherein each one of the hoist modules comprises a first top tubular member and a second top tubular member.

5. The modular hoist system of claim 4, wherein the first top chord and the second top chord pass continuously through the first top tubular member and the second top tubular member, respectively.

6. The modular hoist system of claim 4, wherein the first top chord and the second top chord are configured for being removably attached to the first top tubular member and the second top tubular member, respectively.

7. The modular hoist system of claim 4, wherein the first top tubular member and the second top tubular member are configured to secure the first top chord and the second top chord, respectively, solely by mechanical engagement with a plurality of set screws configured to pass through a corresponding plurality of apertures in the first top tubular member and the second top tubular member, such that loosening the plurality of set screws allows the first top chord and the second top chord to slide out of the first top tubular member and the second top tubular member, respectively.

8. The modular hoist system of claim 4, wherein the first top tubular member comprises a first threaded end, and the second top tubular member comprises a second threaded end.

9. The modular hoist system of claim 8, wherein the first top tubular member and the second top tubular member are configured to secure the first top chord and the second top chord, respectively, solely by mechanical engagement with compression nuts configured to squeeze ferrules or sleeves against the first threaded end and the second threaded end, such that loosening the compression nut allows the first top chord and the second top chord to slide out of the first top tubular member and the second top tubular member.

10. The modular hoist system of claim 1 further comprising a pantograph cable management system disposed above the horizontal truss and configured to route electrical power and control conductors to entertainment fixtures mounted on the horizontal truss, wherein at least one of the support plates includes a cut-out sized to permit movement of pantograph arms while maintaining structural performance of the at least one support plate.

11. The modular hoist system of claim 1, wherein the plurality of hoist modules are dimensioned and configured so that a length of each chord between adjacent support plates is field-selectable, and wherein a length of a corresponding portion of the one or more drive shafts is selected to match the length of the chord, thereby allowing the system to be reconfigured in the field between different overall spans using a common set of hoist modules.

12. The modular hoist system of claim 1, wherein the system is disassemblable, such that the system is transportable and reassemblable into different configurations using mechanical connections instead of welded joints.

13. The modular hoist system of claim 1, wherein each one of the support plates comprises a first top opening configured for being removably coupled to the first top chord, a second top opening configured for being removably coupled to the second top chord, and a third bottom opening configured for being removably coupled to the third bottom chord.

14. The modular hoist system of claim 13, wherein at least one of the support plates comprises a base plate and a plurality of clamping members removably attached to the base plate, wherein the plurality of clamping members form the first top opening, the second top opening, and the third bottom opening.

15. The modular hoist system of claim 14, wherein the plurality of clamping members are attached to the base plate by removable fasteners, such that removing the fasteners allows the clamping members to be separated from the base plate.

16. The modular hoist system of claim 1, wherein each one of the hoist modules comprises a drum support plate having openings comprising splines.

17. The modular hoist system of claim 16, wherein each one of the hoist modules comprises a first top tubular member having a first splined end and a second top tubular member having a second splined end, wherein the first splined end and the second splined end are configured for engaging with the openings in the drum support plate.

18. The modular hoist system of claim 17, wherein the first top tubular member comprises a first flange adjacent to the first splined end and the second top tubular member comprises a second flange adjacent to the second splined end, and wherein the first top tubular member and the second top tubular member are configured for being removably coupled to the drum support plate by positioning the first splined end and the second splined end in the openings in the drum support plate and attaching the first flange and the second flange to a surface of the drum support plate.

19. The modular hoist system of claim 1, wherein at least one of the first hoist module and the second hoist module is mechanically coupled to a corresponding portion of the one or more drive shafts by a removable coupling that permits removal of the corresponding portion of the one or more drive shafts from the hoist module without cutting or welding.

20. The modular hoist system of claim 19, wherein the removable coupling comprises a shaft extending through a cable drum, at least one hub keyed to the shaft, and at least one snap ring disposed in a groove formed in the shaft to retain the hub in an axial position, such that removal of the snap ring allows the hub and the cable drum to be separated from the shaft.
